(19) United States
(12) Patent Application Publication
(10) Pub. No.: US 2004/0055159 A1
(43) Pub. Date: Mar. 25, 2004

(54) V-shaped razor

(76) Inventor: Jeff Khomari, Turlock, CA (US)

Correspondence Address: Richard C. Litman, LITMAN LAW OFFICES, LTD., P.O. Box 15035, Arlington, VA, 22215, US

(21) Appl. No.: 10/660,658

(22) Filed: Sep. 12, 2003

Related U.S. Application Data
(60) Provisional application No. 60/412,022, filed on Sep. 20, 2002.

(51) Int. Cl. B26B 21/16

(52) U.S. Cl. 30/49; 30/50

(57) ABSTRACT

A wet-shaving razor unit for cutting hair from the skin having a V-shaped handle with two elongate rod-like arms pivotally joined together at the vertex, connected by a flexible cross member near their midpoints, an upper portion of the arms being bent forward to make pivotal connection with a flexible blade housing containing one or more elongate blades, having a lubricant on its skin engaging portions, and able to tilt and flex on pivotal connections with the handle, the V-shaped handle and flexible blade head acting in harmony to give safe, close, and comfortable shaves of angular, convex, and concave body surfaces.

### CROSS-REFERENCE TO RELATED APPLICATION

This application claims the benefit of U.S. Provisional Patent Application Serial No. 60/412,022, filed Sep. 20, 2002.

### BACKGROUND OF THE INVENTION

1. Field of the Invention

The present invention relates to manual shaving devices, and in particular to manual wet-shaving devices having handles and flexible blade housings.

2. Description of Related Art

Manual wet-shaving devices are known in which one or more blades are mounted in a flexible, curved, or pivoting housing, cartridge, or blade head that allows the cutting edge to follow the contours of the surface being shaved. Convex and concave blades are frequently used in hospitals where surgical preparation requires shaving boney or angular parts of the body.

Frequently, blade housings are pivotally attached to two forked supports that rise from the ends of elongate razor handles. However, none of these shaving systems is flexibly adjustable to either convex or concave configurations while being drawn across the skin during shaving. Individuals who, for convenience or fashion, shave sharply contoured areas, such as scalps and shins, are often frustrated by safety razors that shave only a narrow strip with each stroke and quickly become dull at their centers. Hence, there is a need for an inexpensive safety razor that flexes to match convex and concave contours of the body while in contact with the area being shaved.

The present invention provides a solution for this problem that is not described in the inventions and patents below.

U.S. Pat. No. 5,333,383, issued to Frank A. Ferraro, describes a razor handle for supporting a flexible blade cartridge, the handle having two arms that extend from one end of an elongate handle and are pivotally attached to a blade cartridge. An additional member that extends from the handle below the cartridge is adjustable to force the blade into a convex form. U.S. Pat. No. 5,855,071, issued to Domenic Vincent Apprille, Jr. et al., discloses a razor handle with two support arms extending from a support assembly, the arms being pivotally attached near the opposite ends of a blade cartridge. Neither of these devices permits both a concave and convex blade configuration.

U.S. Pat. No. 6,161,287, issued to Swanson et al., describes a safety razor system including a blade housing with a handle pivotally attached. Like the '071 patent to Aprille et al., Swanson describes a shaving system with the handle attaching near the ends of the blade cartridge, but does not teach a blade configuration that alternately can be adjusted from convex to concave.

None of the above inventions and patents, taken either singly or in combination, is seen to describe the instant invention as claimed.

### SUMMARY OF THE INVENTION

The present invention is a manual wet-shaving device having a V-shaped handle and a flexible blade housing, head, or cartridge.

The surface of the molded handle of the present invention is textured for gripping. The handle includes two rigid elongate arms connected in a flexible V-shape with the vertex being oriented at the bottom of the handle. In use, the bottom of the handle is cradled in the “life-line” crease of one hand.

A flexible, arcuate cross member connects the arms near their midpoint. The cross member acts as a finger rest where the user can apply gentle pressure while shaving.

At a point near the top of the handle, the arms bend forward to hold the blade housing clear from the grip portion of the handle. A post section of a ball-and-socket joint projects from the upper end of each arm.

Sockets near each end of the blade housing accept the ball portion of the handle arms. The resulting pivotal connections allow the flexible blade housing to bow when shaving convex and concave areas of the body, as well as to tilt in relation to the handle.

In its preferred embodiment, the elongate blade housing holds, but is not limited to, two blades substantially perpendicular to the axis of the V-shaped handle and substantially parallel to the line formed by the upper ends of the handle arms.

Additionally, the face of the blade housing has strips and spots of lubricating gel on surfaces that are drawn across the skin during shaving. Also, a textured finger grip is molded into the surface near each end of the blade housing opposite the cutting edges. The user can apply gentle pressure to either or both finger grips on the blade housing to help shape the curve of the blades to the body part being shaved, or to apply variable pressure across areas where hair density varies.

With gentle downward pressure on the handles, the flexible housing will bow over convex body surfaces such as the scalp and shins. With gentle pressure on the center of the flexible housing, the blade will bow to shave concave areas of the body, such as the armpits.

Accordingly, it is a principal object of the invention to provide a novel shaving system that provides the user with fingertip control of the bow of a flexible razor head, housing, or cartridge while in use so that it will conform to and cleanly shave scalps, shins, armpits, and other concave and convex body parts.

It is another object of the invention to provide a flexible razor head, housing, or cartridge, which tilts while in use so that it will cleanly shave the face and other body parts.

It is a further object of the invention to provide a V-shaped razor which allows the user to vary the pressure on selected portions of the blades as they are drawn across the surface of skin being shaved to accommodate variables, such as hair density.

Still another object of the invention is to provide a V-shaped razor which increases the user's comfort and efficiency by requiring fewer strokes to shave difficult and sensitive areas.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of a V-shaped razor with a flexible blade according to the present invention.

FIG. 2 is a fragmented, exploded side view of the ball-and-socket connection of a handle arm with the blade housing in the V-shaped razor according to the present invention.

FIG. 3 is a plan view of the back of the blade housing of the V-shaped razor according to the present invention.

### DETAILED DESCRIPTION OF THE PREFERRED EMBODIMENTS

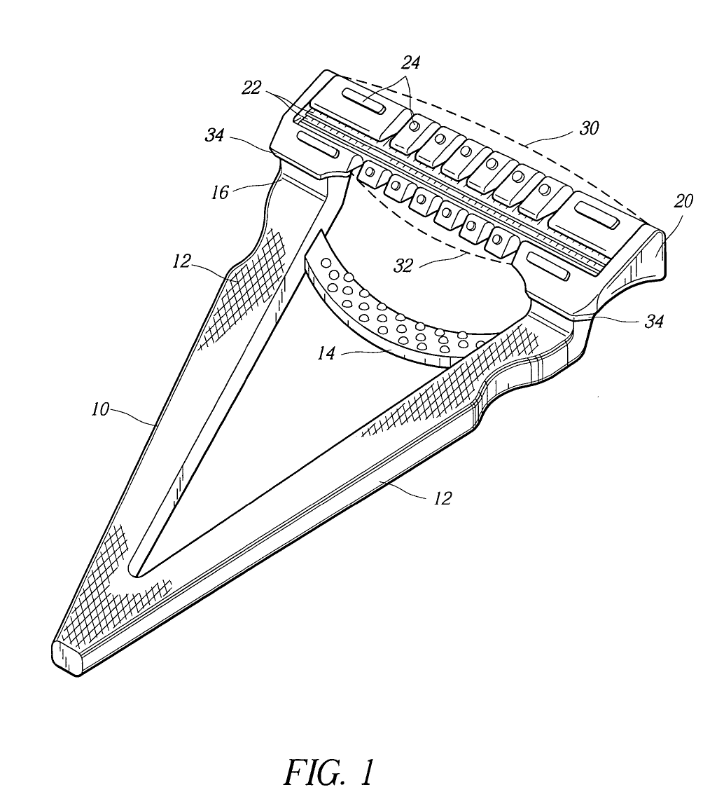

As seen in FIG. 1 the present invention is a manual wet-shaving device having a V-shaped handle 10 and a flexible blade housing 20.

Two rigid rod-like arms 12 of a predetermined length, width, and height connect at one end to form the bottom of the V-shaped handle 10. The two arms 12 may be pivotally connected to each other by a mechanical pivot joint, or by a web of plastic material having sufficient flexibility to allow the arms 12 to pivot may join the arms. A slender, flexible, arcuate cross member 14 bows toward the user's hand between the arms 12, connecting with the arms 12. There is a bend 16 near the distal end of each arm 12 where it rises at an obtuse angle from the axis of its elongate straight portion to keep the user's hand clear of the surface being shaved.

The blade housing 20 holds one or more elongate blades 22 substantially perpendicular to axis X of the V-shaped handle. The cutting edges of the blades 22 project from the housing in parallel planes and at an acute angle to the plane shared by the axes of the handle arms 12. The face of the blade housing has strips and spots of lubricating gel 24 on surfaces that contact the skin during shaving.

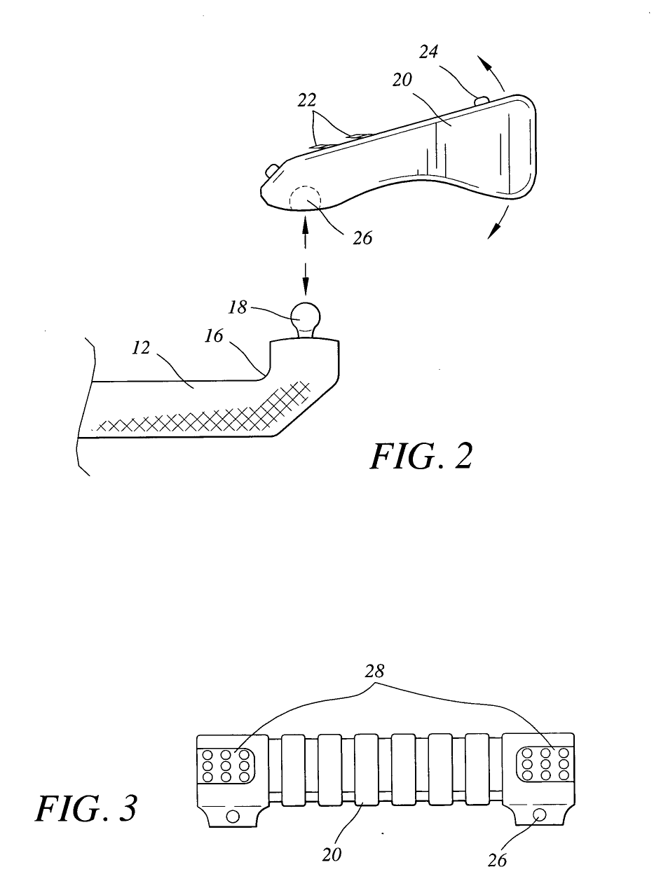

Referring to FIGS. 2 and 3, the ball 18 of a ball-and-socket joint projects from the distal end of each handle arm 12. Each ball 18 locks into a concave spherical socket 26 near an end of the elongate blade housing 20, forming a pivotal connection. The pivotal connection allows the blade housing 20 to tilt within set limits, and, referring to FIG. 1, to bow in convex configurations 30 and concave configurations 32.

As shown in FIGS. 1 and 3, sections of the surface of handle arms 12, cross member 14, and blade housing back 28 are textured for gripping. The user can shape the blade during shaving by applying fingertip pressure to handle arm 12, arcuate cross member 14, either end of the blade housing 28, or any combination thereof.

It is to be understood that the present invention is not limited to the sole embodiment described above, but encompasses any and all embodiments within the scope of the following claims.

I claim:

1. A V-shaped razor, comprising:
two elongate arms, each arm having one end joined to define a vertex, each arm having a distal end opposite the vertex;
a flexible and elongated blade housing pivotally attached between the distal ends of the elongated arms; and
at least one elongate blade mounted to the housing;
wherein the blade housing and the attached blade flex into a concave shape and into a convex shape in order to conform to the contours of a user's body.

2. The V-shaped razor according to claim 1, wherein said elongated arms form a V-shaped handle.

3. The V-shaped razor according to claim 1, further comprising a flexible cross member interconnecting said arms at a position between said vertex and the distal ends of said arms.

4. The V-shaped razor according to claim 1, further comprising gel disposed on said blade housing.

5. The V-shaped razor according to claim 1, wherein the distal ends of said elongated arms are bent forward at an obtuse angle.

6. The V-shaped razor according to claim 1, wherein said housing is pivotally mounted to said elongated arms.

7. The V-shaped razor according to claim 1, wherein each of said elongated arms has a post portion of a post-and-socket joint, said blade housing having opposing ends and sockets defined in the opposing ends, the post portions being received by the sockets.

8. The V-shaped razor according to claim 1, wherein said at least one blade comprises two elongated blades.

9. The V-shaped razor according to claim 1, wherein said elongated arms and said blade housing are made of plastic.

10. The V-shaped razor according to claim 1, wherein said elongated arms and said blade housing each have textured portions.

11. A V-shaped razor, comprising:
two elongate arms, composed of molded plastic, each arm having one end of each arm joined to define a vertex, each arm having a distal end opposite the vertex;
a flexible blade housing pivotally attached between the distal ends of the elongated arms;
at least one elongate blade mounted to the housing;
a flexible cross member interconnecting the arms at a position between the vertex and the distal ends of said arms; and
means for lubricating a user's skin when shaving;
wherein the elongated arms, cross member, and blade housing are textured; and
wherein the blade housing and the attached blade flex into a concave shape and into a convex shape in order to conform to the contours of a user's body.

12. The V-shaped razor device according to claim 11, wherein said lubricating means includes gel disposed on said blade housing.
